(19) United States
(12) Patent Application Publication
(10) Pub. No.: US 2015/0138453 A1
(43) Pub. Date: May 21, 2015

(54) TOUCH PANEL

(71) Applicant: SAMSUNG ELECTRO-MECHANICS CO., LTD, Suwon (KR)

(72) Inventors: In Hyun JANG, Suwon (KR); Jang Ho PARK, Suwon (KR); Jung Ryoul YIM, Suwon (KR); Doo Ho PARK, Suwon (KR)

(73) Assignee: SAMSUNG ELECTRO-MECHANICS CO., LTD, Suwon (KR)

(21) Appl. No.: 14/167,420

(22) Filed: Jan. 29, 2014

(30) Foreign Application Priority Data
Nov. 18, 2013 (KR) 10-2013-0139819

(51) Int. Cl. G06F 3/041

(52) U.S. Cl. CPC G06F 3/041
USPC 349/12

(57) ABSTRACT

There is provided a touch panel, including: a substrate; a print layer provided in an edge region of a surface of the substrate; and a plurality of electrodes configured of a plurality of fine conductor lines and formed on the surface of the substrate and a predetermined surface of the print layer, wherein the fine conductor lines have a larger line width on the surface of the print layer than on the surface of the substrate.

### CROSS-REFERENCE TO RELATED APPLICATION

This application claims the benefit of Korean Patent Application No. 10-2013-0139819 filed on Nov. 18, 2013, with the Korean Intellectual Property Office, the disclosure of which is incorporated herein by reference.

### BACKGROUND

The present disclosure relates to a touch panel.

A touch sensing device such as a touch screen and a touch pad is attached to a display device to provide an intuitive input method to a user, and has recently been widely used in various electronic devices such as cellular phones, personal digital assistant (PDA) and navigation devices. Particularly, as the demand for smart phones has recently increased, touch screens have been increasingly used as they are able to provide various input methods in a limited form factor.

Touch screens used in a portable device may be mainly divided into a resistive type touch screen and a capacitive type touch screen, depending on the way a touch input is sensed. Between these, the capacitive type touch screen has advantages of a relatively longer lifespan and ease of implementing various input manners and gestures, and thus has been employed increasingly frequently. The capacitive type touch screen especially facilitates implementation of a multi-touch interface compared to the resistive type touch screen, and thus is widely used in smart phones and the like.

The capacitive type touch screen includes a plurality of electrodes having a predetermined pattern and the electrodes define a plurality of nodes at which a change in capacitance by a touch input is generated. The nodes deployed in a two-dimensional plane generate a change in self-capacitance or mutual-capacitance through a touch input. Coordinates of the touch input may be calculated by applying a weighted average method or the like to the change in the capacitance generated at the nodes. In existing touch panels, a sensing electrode that senses touch is commonly formed of indium tin oxide (ITO). In the case of ITO, however, indium is a rare-earth element and thus expensive, such that it is not cost competitive. Further, indium is expected to be depleted within 10 years, rendering it difficult to acquire. For these reasons, research into forming an electrode using opaque fine conductor lines is being conducted. The electrode formed using fine conductor lines is advantageous in that it has much better electric conductivity than ITO or conductive polymer and is easily available. However, in order to use such fine conductor lines as electrodes for a touch screen, challenges of making them transparent and less visible and suppressing terminal resistance exist. Patent Document 1 below discloses correcting coordinates at the edge of a capacitive touch screen by increasing the area and decreasing the distance of sensor electrodes at the edge. However, the document relates to implementing an electrode using ITO, not using fine conductor lines, and fails to disclose changing the line width or thickness of the fine conductor lines in a bezel region.

### RELATED ART DOCUMENT

(Patent Document 1) Korean Patent Laid-Open Publication No. 2013-0044432

### SUMMARY

An aspect of the present disclosure may provide a touch panel having a larger line width or a greater thickness of fine conductor lines on a bezel region than on an active region.

According to an aspect of the present disclosure, a touch panel may include: a substrate; a print layer provided in an edge region of a surface of the substrate; and a plurality of electrodes configured of a plurality of fine conductor lines and formed on the surface of the substrate and a predetermined surface of the print layer, wherein the fine conductor lines have a larger line width on the predetermined surface of the print layer than on the surface of the substrate.

The print layer may have a lower surface thereof longer than an upper surface thereof and may have an inclined surface on a side closer to a center region of the substrate.

The fine conductor lines may be formed on the surface of the substrate and the inclined surface of the print layer.

The touch panel may further include a plurality of pads formed on the upper surface of the print layer.

The fine conductor lines formed on the inclined surface of the print layer may be extended to the upper surface of the print layer.

The fine conductor lines formed on the inclined surface of the print layer may be connected to the plurality of pads.

The fine conductor lines may be formed of any one of Ag, Al, Cr, Ni, Mo, Cu and Ti, or an alloy of at least two of Ag, Al, Cr, Ni, Mo, Cu and Ti.

The fine conductor lines may be formed in a mesh pattern.

The center region of the substrate may correspond to an active region, and the edge region of the substrate may correspond to a bezel region.

According to another aspect of the present disclosure, a touch panel may include: a substrate; a print layer provided in an edge region of a surface of the substrate; and a plurality of electrodes configured of a plurality of fine conductor lines and formed on the surface of the substrate and on a predetermined surface of the print layer, wherein the fine conductor lines have a greater thickness on the predetermined surface of the print layer than on the surface of the substrate.

The print layer may have a lower surface thereof longer than an upper surface thereof and may have an inclined surface on a side closer to a center region of the substrate.

The fine conductor lines may be formed on the surface of the substrate and the inclined surface of the print layer.

The touch panel may further include a plurality of pads formed on the upper surface of the print layer.

The fine conductor lines formed on the inclined surface of the print layer may be extended to the upper surface of the print layer.

The fine conductor lines formed on the inclined surface of the print layer may be connected to the plurality of pads.

The fine conductor lines may be formed of any one of Ag, Al, Cr, Ni, Mo, Cu and Ti, or an alloy of at least two of Ag, Al, Cr, Ni, Mo, Cu and Ti.

The fine conductor lines may be formed in a mesh pattern.

The center region of the substrate may correspond to an active region, and the edge region of the substrate may correspond to a bezel region.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view illustrating an appearance of an electronic device including a touch panel according to an exemplary embodiment of the present disclosure;

FIG. 2 is a front view of a touch panel according to an exemplary embodiment of the present disclosure;

FIG. 3 is a front view of a touch panel according to another exemplary embodiment of the present disclosure;

FIG. 4 is an enlarged view of portion A of the touch panel according to the exemplary embodiment of the present disclosure illustrated in FIG. 2; and

FIG. 5 is a cross-sectional view taken along line B-B′ of the touch panel according to the exemplary embodiment of the present disclosure illustrated in FIG. 2.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

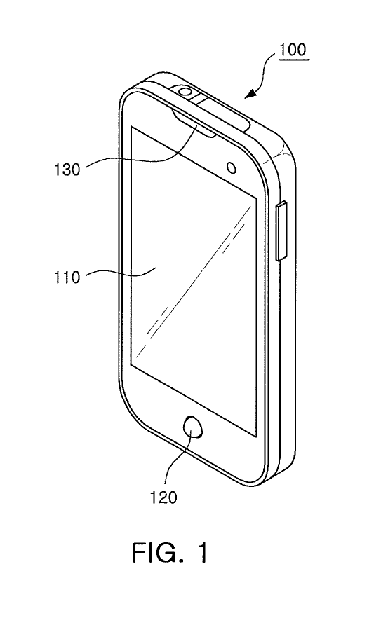

FIG. 1 is a perspective view illustrating an appearance of an electronic device including a touch panel according to an exemplary embodiment of the present disclosure.

Referring to FIG. 1, the electronic device 100 according to the exemplary embodiment may include a display device 110 for displaying a screen, an input unit 120, an audio unit 130 for outputting sound, and a touch screen device integrated with the display device 110. A touch panel may be included in the touch screen device.

As illustrated in FIG. 1, it is common in mobile devices for a touch screen device to be integrated with a display device, and such a touch screen device needs to have light transmittance so high that a screen displayed on the display device can be seen. Accordingly, such a touch screen device may be implemented by forming an electrode with a conductive material on a transparent substrate formed of a film such as polyethylene terephthalate (PET), polycarbonate (PC), polyethersulfone (PES), polyimide (PI), polymethylmethacrylate (PMMA), and cyclo-olefin polymer (COP), soda glass, or tempered glass. In a bezel area of the display device, wiring patterns connected to electrodes formed of a transparent, conductive material are arranged, and the wire patterns are shielded by the bezel area so that they are not visible.

Since the touch screen device according to the exemplary embodiment is a capacitive type, the touch screen device may include a plurality of electrodes having a predetermined pattern. Further, the touch screen device may include a capacitance sensing circuit to sense a change in the capacitance generated in the plurality of electrodes, an analog-digital converting circuit to convert an output signal from the capacitance sensing circuit into a digital value, and a calculating circuit to determine whether a touch input is made using the converted digital value.

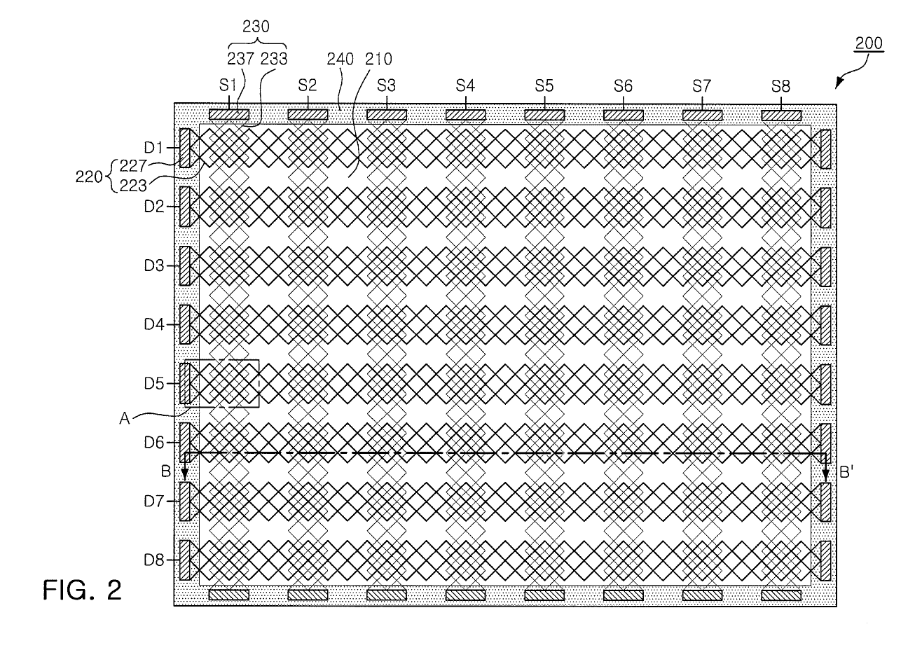

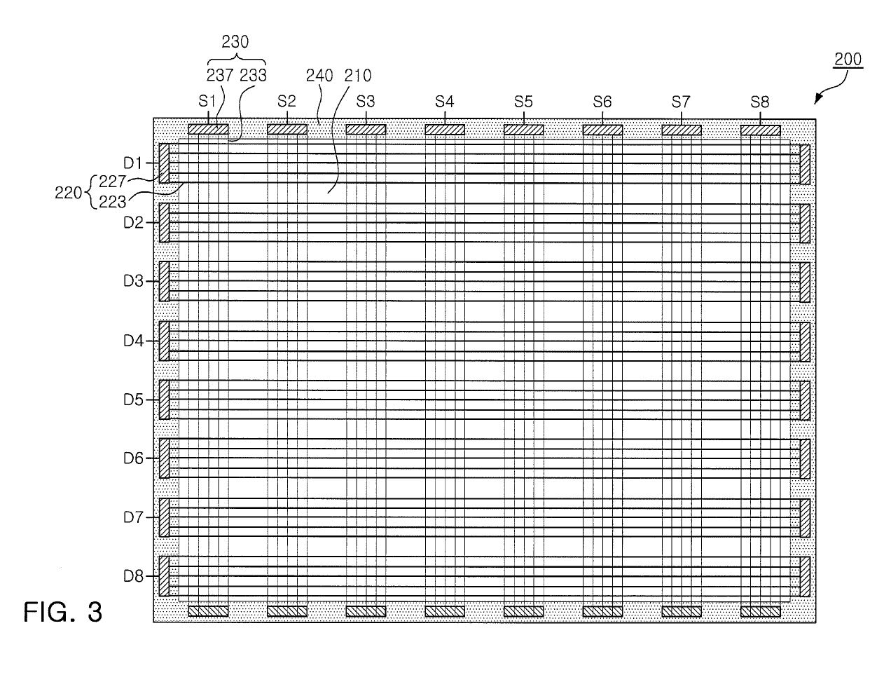

FIG. 2 is a front view of a touch panel according to an exemplary embodiment of the present disclosure, and FIG. 3 is a front view of a touch panel according to another exemplary embodiment of the present disclosure.

Referring to FIG. 2, a touch panel 200 according to the exemplary embodiment may include a substrate 210 and a plurality of electrodes 220 and 230 provided on the substrate 210. Although not illustrated in FIG. 2, each of the plurality of electrodes 220 and 230 may be electrically connected to a flexible circuit board attached to one side of the substrate 210 through connection wiring and a bonding pad. The flexible circuit board may have a controller integrated circuit mounted thereon in order to detect a sensing signal generated in the plurality of electrodes 220 and 230, and may determine whether a touch is input based on the detected sensing signal.

The substrate 210 may be a transparent substrate on which the plurality of electrodes 220 and 230 are to be formed. Accordingly, as described above, the substrate 210 may be formed of films such as polyethylene terephthalate (PET), polycarbonate (PC), polyethersulfone (PES), polyimide (PI), polymethylmethacrylate (PMMA), and cyclo-olefin polymer (COP), soda glass, or tempered glass.

The plurality of electrodes 220 and 230 may include first electrodes 220 extending in the x-axis direction, and second electrodes 230 extending in the y-axis direction. The first electrodes 220 and the second electrodes 230 may be provided on the same surface or different surfaces of the substrate 210 (see FIG. 5). When the first and second electrodes 220 and 230 are provided on the same surface of the substrate 210, the first electrodes 220 and the second electrodes 230 may have insulation layers partially formed at intersection points therebetween. Alternatively, the first electrodes 220 and the second electrodes 230 may be provided on different surfaces so as to intersect with each other.

In particular, according to the exemplary embodiment, the substrate 210 may be formed of tempered glass, for example, so as to directly receive a touch input, and may have the plurality of electrodes 220 and 230 formed on the surface opposite to the surface at which a touch input is received. That is, the touch panel according to the exemplary embodiment may be a touch panel integrated with a window.

A device, electrically connected to the plurality of electrodes 220 and 230 to sense a touch input, detects a change in capacitance generated in the plurality of electrodes 220 and 230 through a touch input and senses the touch input based on the detected change in capacitance. The first electrodes 220 may be connected to channels defined as D1 to D8 in the controller integrated circuit to receive predetermined driving signals, and the second electrodes 230 may be connected to channels defined as S1 to S8 to detect a change in capacitance generated between the first electrodes 220 and the second electrodes 230. Here, the controller integrated circuit may use a change in the capacitance as a sensing signal to determine whether touch is input.

The plurality of electrodes 220 and 230 may include a plurality of conductor fine lines 223 and 233, and pads 227 and 237 electrically connected to the plurality of conductor fine lines 223 and 233 at terminals thereof. Typically, the plurality of fine conductor lines 223 and 233 is formed in a mesh pattern, such that patterning marks are less visible in the region in which traditional indium-tin oxide (ITO) electrodes exist and transparency of a touch panel may be improved.

Although the fine conductor lines 223 and 233 in the plurality of electrodes 220 and 230 is formed in a diamond shape or a quadrangular shape in FIG. 2, the shape of the plurality of fine conductor lines 225 and 235 is not limited thereto and may be formed in any shape that is obvious to or easily conceived by those skilled in the art such as a hexagonal shape, an octagonal shape, a diamond shape and a random shape. In FIG. 3, for example, the plurality of fine conductor lines 225 and 235 is formed in a line shape.

The fine conductor lines 223 and 233 forming the plurality of electrodes 220 and 230 may be formed of one of Ag, Al, Cr, Ni, Mo, Cu, and Ti or an alloy thereof. By forming the plurality of electrodes 220 and 230 with metal, the resistance value of an electrode may be reduced to thereby improve conductivity and detection sensitivity.

In the regions in which pads 227 and 237, electrically connected to the plurality of fine conductor lines 223 and 233, are provided, a print layer 240 may be provided on the substrate 210 in order to hide the pads 227 and 237 typically formed of an opaque metal material. The pads 227 and 237 are provided on the print layer 240 provided at the periphery of the substrate 210, and the pads 227 and 237 come in contact with the plurality of fine conductor lines 223 and 233 on the print layer 240.

When a plurality of fine conductor lines 223 and 233 having a line width between 0.5 μm and 10 μm is connected to the pads 227 and 237 on the print layer 240, the fine conductor lines 223 and 233 may be short-circuited due to a level difference in thickness of the print layer 240.

According to the exemplary embodiment, by making the line width of the fine conductor lines 223 and 233 formed on the print layer 240 wider than the line width of the fine conductor lines 223 and 233 formed on the substrate 210, it may be possible to prevent the fine conductor lines 223 and 233 from being short-circuited due to the thickness of the print layer 240. In addition, short-circuit may be prevented by increasing the thickness, instead of the line width.

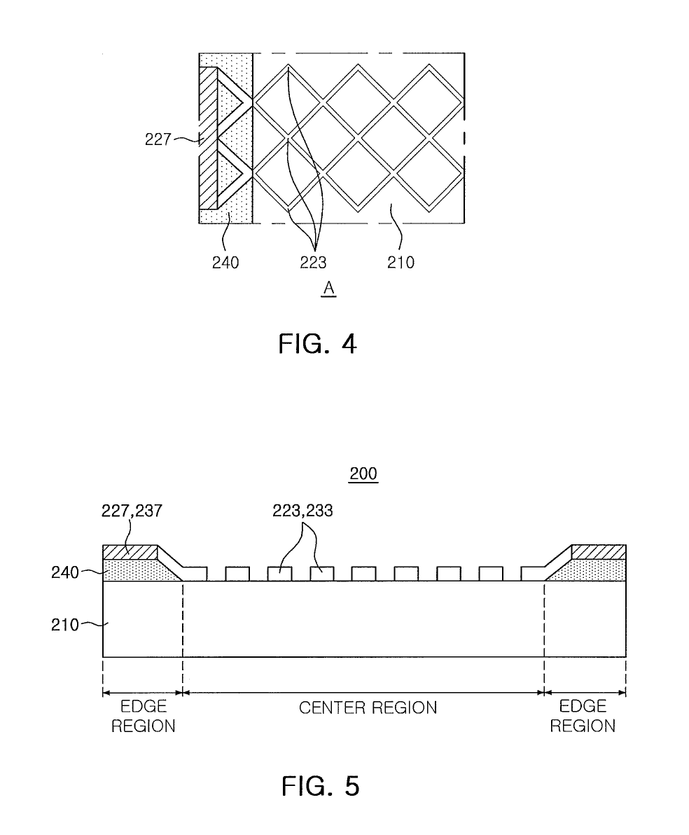

In the following description, the touch panel according to the exemplary embodiment may be described in more detail with reference to FIGS. 4 and 5.

FIG. 4 is an enlarged view of portion A of the touch panel according to the exemplary embodiment of the illustrated in FIG. 2.

Referring to FIG. 4, the plurality of fine conductor lines 223 is formed on the substrate 210 and on the print layer 240 provided on the substrate 210, and may have a larger line width on the print layer 240 than on the substrate 210. Although FIG. 4 only illustrates the fine conductor lines 223 forming the first electrodes 220 of FIG. 2, the fine conductor lines 233 forming the second electrodes 230 may also have a line width determined in the same manner as the fine conductor lines 223 forming the first electrodes 220.

Further, as described above, the fine conductor lines 223 may have a greater thickness on the print layer 240 than on the substrate 210.

FIG. 5 is a cross-sectional view taken along line B-B′ of the touch panel according to the exemplary embodiment of the illustrated in FIG. 2. For the convenience of illustration, the plurality of fine conductor lines 223 and 233 configuring the plurality of electrodes 220 and 230 illustrated in FIG. 2 is somewhat exaggerated in FIG. 5.

In FIG. 5, an edge region refers to a region in which the print layer 240 is formed of an opaque material so as to hide the pads 227 and 237, connection wiring (not shown), a flexible circuit board (not shown), and the like, i.e., a bezel region, and a center region refers to the region other than the edge region in which a touch input by a user is input and a screen output from the display device integrated with the touch panel is viewed by a user, i.e., an active region.

As illustrated in FIG. 5, the print layer 240 provided in the edge region may have a lower surface thereof longer than an upper surface thereof, and may have an inclined surface with a predetermined angle on the side closer to the center region. The pads 227 and 237 may be provided on a part or an entirety of the upper surface of the print layer 240 so as to be electrically connected to the fine conductor lines 223 and 233. In FIG. 5, the fine conductor lines 223 and 233 are formed only on the inclined surface but not on the upper surface of the print layer 240. However, the fine conductor lines 223 and 233 may extend to the upper surface of the print layer 240 so as to be connected to the pads 227 and 237 on the upper surface of the print layer 240.

In the exemplary embodiment, of two side surfaces of the print layer 240, a surface closer to the center region is formed as the inclined surface, so that short-circuit of the fine conductor lines 223 and 233 may be prevented. However, even if the fine conductor lines 223 and 233 are extended along the inclined surface of the print layer 240, the fine conductor lines 223 and 233 may be short-circuited due to the angle of the inclined surface. According to the exemplary embodiment, the fine conductor lines 223 and 233 have line width or thickness in the edge region larger or thicker than in the center region, so that short-circuit may be more effectively prevented.

As set forth above, according to exemplary embodiments of the present disclosure, a line width of fine conductor lines is larger on a bezel region than on an active region, such that a short-circuit caused by a level difference of the print layer provided on the bezel region may be prevented.

While exemplary embodiments have been shown and described above, it will be apparent to those skilled in the art that modifications and variations could be made without departing from the spirit and scope of the present disclosure as defined by the appended claims.

What is claimed is:

1. A touch panel, comprising:
a substrate;
a print layer provided in an edge region of a surface of the substrate; and
a plurality of electrodes configured of a plurality of fine conductor lines and formed on the surface of the substrate and a predetermined surface of the print layer,
wherein the fine conductor lines have a larger line width on the predetermined surface of the print layer than on the surface of the substrate.

2. The touch panel of claim 1, wherein the print layer has a lower surface thereof longer than an upper surface thereof and has an inclined surface on a side closer to a center region of the substrate.

3. The touch panel of claim 2, wherein the fine conductor lines are formed on the surface of the substrate and the inclined surface of the print layer.

4. The touch panel of claim 2, further comprising a plurality of pads formed on the upper surface of the print layer.

5. The touch panel of claim 4, wherein the fine conductor lines formed on the inclined surface of the print layer are extended to the upper surface of the print layer.

6. The touch panel of claim 5, wherein the fine conductor lines formed on the inclined surface of the print layer are connected to the plurality of pads.

7. The touch panel of claim 1, wherein the fine conductor lines are formed of any one of Ag, Al, Cr, Ni, Mo, Cu and Ti, or an alloy of at least two of Ag, Al, Cr, Ni, Mo, Cu and Ti.

8. The touch panel of claim 1, wherein the fine conductor lines are formed in a mesh pattern.

9. The touch panel of claim 2, wherein the center region of the substrate corresponds to an active region, and the edge region of the substrate corresponds to a bezel region.

10. A touch panel, comprising:
a substrate;
a print layer provided in an edge region of a surface of the substrate; and
a plurality of electrodes configured of a plurality of fine conductor lines and formed on the surface of the substrate and on a predetermined surface of the print layer,
wherein the fine conductor lines have a greater thickness on the predetermined surface of the print layer than on the surface of the substrate.

11. The touch panel of claim 10, wherein the print layer has a lower surface thereof longer than an upper surface thereof and has an inclined surface on a side closer to a center region of the substrate.

12. The touch panel of claim 11, wherein the fine conductor lines are formed on the surface of the substrate and the inclined surface of the print layer.

13. The touch panel of claim 11, further comprising a plurality of pads formed on the upper surface of the print layer.

14. The touch panel of claim 13, wherein the fine conductor lines formed on the inclined surface of the print layer are extended to the upper surface of the print layer.

15. The touch panel of claim 14, wherein the fine conductor lines formed on the inclined surface of the print layer are connected to the plurality of pads.

16. The touch panel of claim 10, wherein the fine conductor lines are formed of any one of Ag, Al, Cr, Ni, Mo, Cu and Ti, or an alloy of at least two of Ag, Al, Cr, Ni, Mo, Cu and Ti.

17. The touch panel of claim 10, wherein the fine conductor lines are formed in a mesh pattern.

18. The touch panel of claim 11, wherein the center region of the substrate corresponds to an active region, and the edge region of the substrate corresponds to a bezel region.
